(19) United States
(12) Patent Application Publication
(10) Pub. No.: US 2007/0171589 A1
(43) Pub. Date: Jul. 26, 2007

(54) Zapping Circuit

(75) Inventor: Seiji Otake, Saitama (JP)

Correspondence Address: FISH & RICHARDSON P.C., P.O. BOX 1022, MINNEAPOLIS, MN, 55440-1022, US

(73) Assignee: Sanyo Electric Co., Ltd.

(21) Appl. No.: 11/620,250

(22) Filed: Jan. 5, 2007

(30) Foreign Application Priority Data
Jan. 20, 2006 (JP) P2006-012141

(51) Int. Cl. H02H 9/00

(52) U.S. Cl. 361/58

(57) ABSTRACT

In a zapping circuit of the present invention, resistances each formed of a polysilicon film or a tungsten silicon film are used as zapping elements. As driver elements for partially or completely fusing the resistances, low breakdown voltage MOS transistors are used. Using the MOS transistors makes it possible to reduce a region in which to form the driver elements for zapping, and to thus reduce an IC chip area.

### BACKGROUND OF THE INVENTION

Priority is claimed to Japanese Patent Application Number JP2006-012141 filed on Jan. 20, 2006, the disclosure of which is incorporated herein by reference in its entirety.

1. Field of the Invention

The present invention relates to a zapping circuit which controls circuit characteristics by partially or completely fusing a resistance to fluctuate a resistance value.

2. Description of the Related Art

In a conventional current regulation circuit, for example, a voltage of a predetermined level or more is applied to a Zener diode to zap the Zener diode, and thereby a reference current is regulated. Moreover, regulating the reference current makes it possible to control circuit characteristics such as an oscillation frequency with high accuracy. As one example of the conventional current regulation circuit, there is a circuit in which bipolar transistors and Zener diodes are utilized as shown in FIG. 4. For example, in current supply transistors 41 to 46, collectors are connected in parallel, emitters are grounded, and bases are respectively connected to switching circuits 47 to 52. The switching circuits 47 to 52 include Zener diodes for zapping. In each of the switching circuits 47 to 52, a voltage of a predetermined level or more is applied to the Zener diode through each of terminal pads Pad1 to Pad6. Thereafter, depending on a destroyed or undestroyed state of the Zener diode, a signal is outputted. This technology is described for instance in Japanese Patent Application Publication No. 2002-261243 (Pages 2 to 4, FIGS. 1 to 3).

In a conventional trimming circuit, a regulating method called Zener-zap trimming is known as means for correcting, in the final stage of manufacturing steps, an element error caused by a limit of accuracy in manufacturing an analog integrated circuit. Specifically, when a current pulse of a certain energy or more is applied to a Zener diode in a reverse direction, the Zener diode is destroyed and permanently short-circuited. The trimming circuit uses a nonvolatile on switch which utilizes the above phenomenon and which is, so to speak, writable only once. In order to enable zapping after package sealing, the trimming circuit includes: a bias current source, zapping switch transistors, switches for determining on/off operations of the zapping switch transistors, and a decoder circuit for controlling the switches. In zapping the Zener diodes, a voltage of tens of volts is applied, and high breakdown voltage transistors are required as the zapping switch transistors. To meet this requirement, the zapping switch transistors are stacked vertically in series to secure the breakdown voltage. Moreover, by use of the zapping switch transistors having a three-stage Darlington configuration, a large current pulse is controlled from a small drive current in a control circuit. This technology is described for instance in Japanese Patent Application Publication No. Hei 6 (1994)-140512 (Pages 6 to 10, FIGS. 1 to 5).

As described above, in the conventional current regulation circuit, since the terminal pads are used for zapping the Zener diodes, a zapping step is performed in a wafer state before package sealing. For this reason, there arises a problem that the controlled circuit characteristics are changed by stress between an IC chip and a resin in resin molding. Moreover, drawing of all the terminal pads as leads out of the package increases the number of pins and thus is not economical. As a result, there arises a problem that the changed circuit characteristics cannot be controlled any longer by zapping after the package is formed.

Moreover, in the conventional current regulation circuit, the circuit characteristics are controlled by zapping the Zener diodes in the wafer state before package sealing. For this reason, an IC chip user, for example, an assembled product manufacturer faces a problem that it is impossible to control overall characteristics including a variation in the circuit characteristics in a state close to a final product form after assembly.

Meanwhile, in the conventional trimming circuit, a plurality of zapping switch transistors for zapping the Zener diodes have to be formed. For this reason, a circuit scale required for zapping the Zener diodes is increased on the IC chip. Consequently, there arises a problem that it is impossible to reduce an area of the IC chip.

### SUMMARY OF THE INVENTION

The present invention has been made in consideration for the foregoing circumstances. A zapping circuit of the present invention includes resistances connected to a power supply circuit and transistors which respectively supply currents to the resistances. The zapping circuit includes that each of the transistors has a current capability to partially or completely fuse the resistance. As a result, in the present invention, use of the resistances which can be fused with a low current and a low voltage makes it possible to reduce a region in which to form driver elements for zapping. Thus, it is possible to reduce an IC chip area.

Moreover, the zapping circuit of the present invention includes that the transistors are MOS transistors. As a result, in the present invention, use of the MOS transistors as the driver elements for zapping makes it possible to reduce the region in which to form the driver elements.

The zapping circuit of the present invention further includes a control circuit which controls operations of the MOS transistors, and includes that the MOS transistors are operated based on control signals from the control circuit. As a result, in the present invention, it is possible to partially or completely zap the resistances even after packaging the IC chip.

Moreover, the zapping circuit of the present invention includes that the plurality of resistances and the plurality of MOS transistors are respectively paired with each other, and connected in parallel to the power supply circuit. Moreover, the zapping circuit includes that the MOS transistors are selectively turned on based on the control signals from the control circuit. As a result, in the present invention, selectively turning on the MOS transistors makes it possible to selectively zap the resistances partially or completely.

The zapping circuit of the present invention further includes a sense circuit which detects a change in resistance values of the resistances. As a result, in the present invention, using the sense circuit to detect the changes in the resistance values of the resistances makes it possible to control circuit characteristics by utilizing the detection result.

Moreover, the zapping circuit of the present invention includes that each of the resistances is formed of a polysilicon film or a tungsten silicon film. As a result, in the present invention, it is possible to form the resistances which are partially or completely fused with a low current and a low voltage by use of the polysilicon film or the tungsten silicon film.

Moreover, the zapping circuit of the present invention includes that the resistances have resistance values of 10Ω to 1 kΩ. As a result, in the present invention, it is possible to zap the resistances by the MOS transistors each having a desired current capacity.

### BRIEF DESCRIPTION OF THE DRAWINGS

FIG. 1 is a circuit diagram illustrating a switching circuit according to an embodiment of the present invention.

FIG. 2 is a circuit diagram illustrating a current regulation circuit according to the embodiment of the present invention.

FIG. 3A is a circuit diagram illustrating a sense circuit using NPN transistors, and FIG. 3B is a circuit diagram illustrating a sense circuit using N-channel MOS transistors according to the embodiment of the present invention.

FIG. 4 is a circuit diagram showing a current regulation circuit according to a conventional embodiment.

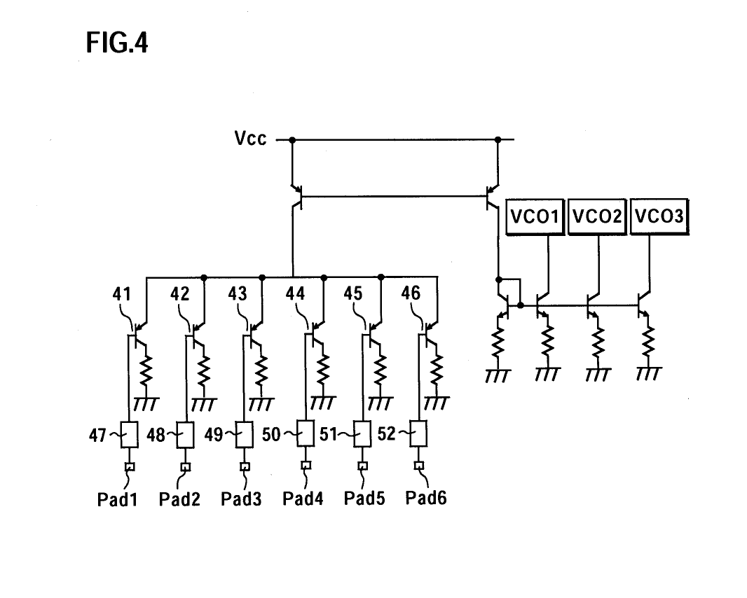

### DESCRIPTION OF THE EMBODIMENTS

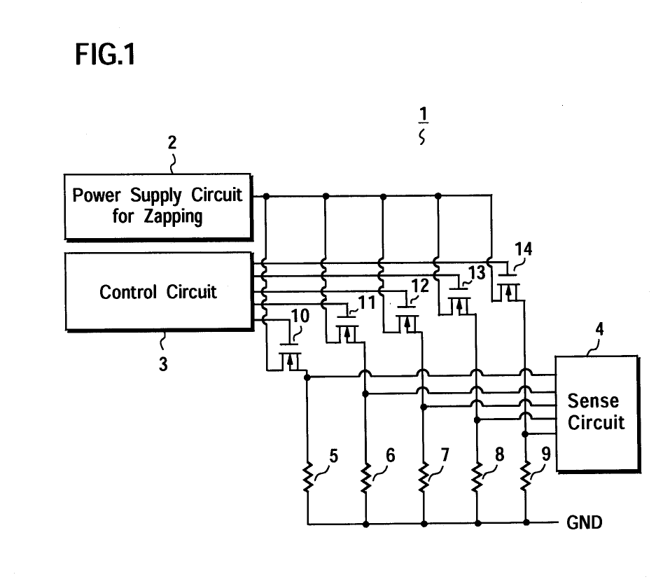

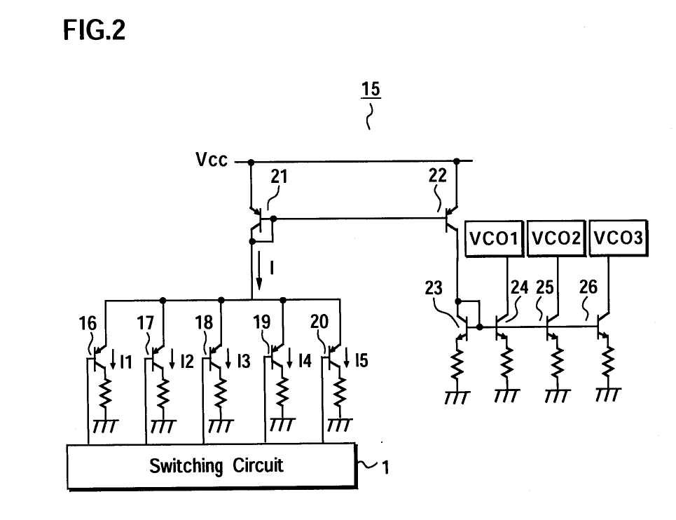

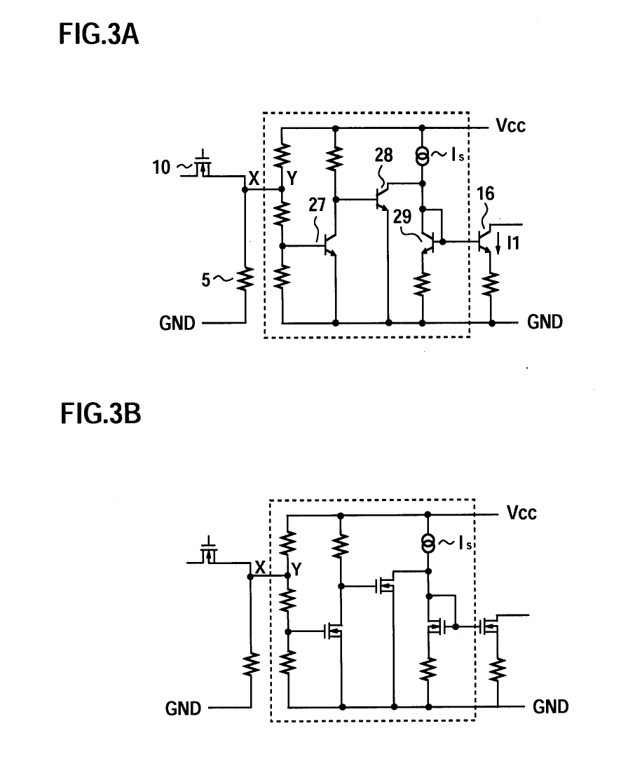

With reference to FIGS. 1 to 3B, detailed description will be given below of a current regulation circuit according to an embodiment of the present invention. FIG. 1 is a circuit diagram showing a switching circuit according to this embodiment. FIG. 2 is a circuit diagram showing the current regulation circuit according to this embodiment. FIGS. 3A and 3B are circuit diagrams showing sense circuits according to this embodiment.

As shown in FIG. 1, a switching circuit 1 includes: a power supply circuit (supply side) 2 for zapping, a control circuit 3, a sense circuit 4, resistances 5 to 9 for zapping, and MOS transistors 10 to 14 for driver.

Drain electrodes of the MOS transistors 10 to 14 for driver are connected to the power supply circuit 2 for zapping. A zapping potential is supplied from the power supply circuit 2 for zapping. The zapping potential is a potential required to give a large change in a resistance value of each of the resistances 5 to 9. It is possible to arbitrarily set the potential based on a relationship with each of the resistances 5 to 9. Moreover, gate electrodes of the MOS transistors 10 to 14 are connected to the control circuit 3. The MOS transistors 10 to 14 are turned on or off based on control signals from the control circuit 3. Furthermore, source electrodes of the MOS transistors 10 to 14 are respectively connected to the resistances 5 to 9.

The control circuit 3 is a circuit which controls the turning on and off of the MOS transistors 10 to 14. The control circuit 3 is configured of elements that can be included in an IC chip, for example, N-channel MOS transistors, P-channel MOS transistors, NPN transistors, PNP transistors and the like. Moreover, a signal for selectively turning on the MOS transistors 10 to 14 is inputted to the control circuit 3 from one of leads exposed after resin molding. The control circuit 3 demodulates and modulates the input signal to turn on the MOS transistors 10 to 14 respectively connected to the resistances 5 to 9 to be zapped. Accordingly, desired currents flow through the resistances 5 to 9 respectively connected to the turned on MOS transistors 10 to 14, and the resistances are partially or completely fused. Thus, the resistance values thereof are significantly changed.

The sense circuit 4 detects significantly changed or unchanged states of the resistance values respectively of the resistances 5 to 9. Specifically, the sense circuit 4 detects a low potential (a GND potential or a potential close to the GND potential) in a case where the resistance values respectively of the resistances 5 to 9 are significantly changed. On the other hand, the sense circuit 4 detects a high potential (the zapping potential or a potential close to the zapping potential) in a case where the resistance values respectively of the resistances 5 to 9 are unchanged.

The resistances 5 to 9 are formed of, for example, polysilicon films, tungsten silicon films or the like. Although it suffices to use a conductive material to form the resistances 5 to 9, using the same material as that of the gate electrodes of the MOS transistors 10 to 14 makes it possible to simplify a manufacturing process. Moreover, the resistances 5 to 9 are formed to have resistance values respectively of, for example, 10Ω to 1 kΩ. This is for the following reasons. For example, in a case where the resistance values of the resistances 5 to 9 are smaller than 10Ω, current values in zapping the resistances 5 to 9 are increased. As a result, a MOS transistor size is increased depending on a desired current capacity, and reduction in a chip size becomes difficult. Moreover, for example, in a case where the resistance values of the resistances 5 to 9 are larger than 1 kΩ, potentials in zapping the resistances 5 to 9 are increased. As a result, high breakdown voltage MOS transistors are required to be formed, the MOS transistor size is increased, and reduction in the chip size becomes difficult.

In this embodiment, the MOS transistors 10 to 14 are turned off in a normal operation, and are selectively turned on in zapping the resistances 5 to 9. Thus, a thickness T, a width W, a length L and the like of each of the resistances 5 to 9 are designed so that the resistances 5 to 9 are partially or completely fused by currents supplied from the MOS transistors 10 to 14.

For example, in the case where the resistances 5 to 9 are formed in the same step as that of the gate electrodes of the MOS transistors, the resistances 5 to 9 are arbitrarily designed to have the film thickness set constant, the width W of 0.3 to 8.0 μm and the length L of 1.0 to 20.0 μm. In the case where the resistances 5 to 9 are formed of the polysilicon films, when the width W of each of the resistances 5 to 9 is 0.6 μm or less and the length L thereof is 2.0 μm or less, a zapping voltage is increased in response to reduction in the width W, and a zapping current is increased in response to reduction in the length L. As a result, in a case where the width W of each of the resistances 5 to 9 is 0.6 μm and the length L thereof is 2.0 μm, the zapping current and the zapping voltage are minimized. Thus, by reducing the zapping current, it is possible to reduce the size of each of the MOS transistors 10 to 14, and to reduce an IC chip area.

The MOS transistors 10 to 14 are selectively turned on based on the signals from the control circuit 3. When the MOS transistors 10 to 14 are turned on, predetermined currents flow through the resistances 5 to 9. Accordingly, the resistances 5 to 9 are partially or completely fused, and the resistance values thereof are significantly changed.

As shown in FIG. 2, a current regulation circuit 15 regulates a reference current I by selectively turning on the MOS transistors 10 to 14 to allow the predetermined currents to flow through the resistances 5 to 9 (see FIG. 1) and to significantly change the resistance values respectively of the resistances 5 to 9 as described above. The reference current I is a current obtained by combining currents generated by current supply transistors 16 to 20. The regulated reference current I generated by the current supply transistors 16 to 20 is transmitted by a first current mirror circuit including PNP transistors 21 and 22. Subsequently, after a current polarity of the regulated reference current I is inverted by a second current mirror circuit including NPN transistors 23 to 26, the reference current is supplied to a plurality of voltage control oscillation circuits (hereinafter called “VCO”) VCO1, VCO2 and VCO3 at the same time.

The sense circuit using NPN transistors, shown in FIG. 3A, is a circuit configuration example in the case of detecting a changed or unchanged state of the resistance value of the resistance 5 shown in FIG. 1. Note that the same circuit configuration is adopted also in the case of detecting fused or unfused states of the other resistances 6 to 9.

When the MOS transistor 10 is turned on by the control signal from the control circuit 3 (see FIG. 1), and the current from the MOS transistor 10 is supplied to the resistance 5, the resistance 5 is partially or completely fused, and a potential at a contact point X becomes the zapping potential. Accordingly, since a base potential of an NPN transistor 27 is set at a predetermined level by division of resistance, the NPN transistor 27 is turned on. Thus, since an NPN transistor 28 is turned off, a current from a current source Is flows toward an NPN transistor 29, and a current I1 flows through a current supply transistor 16 which constitutes a current mirror.

Meanwhile, when the MOS transistor 10 is not turned on and the resistance 5 is in the unfused state (the unchanged state of the resistance value), the potential at the contact point X becomes lower than a potential at a contact point Y. Accordingly, the NPN transistor 27 is turned off, a base potential of the NPN transistor 28 is increased to a power source Vcc level, and the NPN transistor 28 is turned on. As a result, since the current from the current source Is flows into the NPN transistor 28, no current flows through the NPN transistor 29. Thus, no current flows through the current supply transistor 16 which constitutes the current mirror together with the NPN transistor 29 on the output.

As a result, the MOS transistors 10 to 14 are controlled by use of the control signals from the control circuit 3, and the resistances 5 to 9 are selectively zapped. Thus, it is possible to regulate the reference current I with high accuracy.

Note that, as shown in FIG. 3B, it is possible to realize the same circuit operations also in a case where the NPN transistors used in the description of FIG. 3A are replaced with N-channel MOS transistors. In this event, the current supply transistors 16 to 20 are also replaced with N-channel MOS transistors. In this case, using the N-channel MOS transistors makes it also possible to reduce a region in which the sense circuit 4 is formed, and to reduce the IC chip area.

As described above, in this embodiment, the resistances 5 to 9 are used as zapping elements, and the low breakdown voltage MOS transistors 10 to 14 are used as driver elements for zapping. This is because it is possible to partially or completely fuse the resistances 5 to 9 with a lower voltage and a lower current, compared with the case where Zener diodes are used as the driver elements. Moreover, a region in which to form elements is smaller for the low breakdown voltage MOS transistors 10 to 14 than for high breakdown voltage bipolar transistors. Specifically, compared with the case where the Zener diodes are zapped by the high breakdown voltage bipolar transistors, the region in which to form the driver elements is reduced to ⅕ or less.

For example, by replacing the high breakdown voltage bipolar transistors with the low breakdown voltage MOS transistors as the driver elements on the same IC chip area, the region in which to form elements on the IC chip is efficiently utilized. Moreover, a region in which to form memories is increased, and a memory capacity is increased from about 10 bits to about 100 bits.

Note that, also in a case where pads are used in place of the high breakdown voltage bipolar transistors, the region in which to form the low breakdown voltage MOS transistors is similarly reduced to be smaller than a pad area. As a result, the region in which to form elements on the IC chip is efficiently utilized. Moreover, for example, the high breakdown voltage bipolar transistors are transistors having a breakdown voltage characteristic of about 20 V for supplying a voltage and a current required to zap the Zener diodes. Meanwhile, the low breakdown voltage MOS transistors are transistors having a breakdown voltage characteristic of 10 V or less for supplying a voltage and a current required to zap the resistances formed of the polysilicon films or the like.

Moreover, using the resistances 5 to 9 makes it possible to utilize the low breakdown voltage MOS transistors 10 to 14 as the driver elements. The low breakdown voltage MOS transistors 10 to 14 have a small region (area) in which to form them. Moreover, since the low breakdown voltage MOS transistors 10 to 14 are voltage control elements, power consumption is also small. Thus, it is possible to control the operations of the MOS transistors 10 to 14 by the control circuit 3 formed within the same IC chip. As a result, for example, even in a case where circuit characteristics are changed by resin stress or the like in resin molding of the IC chip, it is possible to control the circuit characteristics thereafter by conducting circuit characteristic tests and zapping the resistances 5 to 9. Moreover, the same goes for a circuit characteristic test in a state close to a final product form after assembly. Specifically, using the control circuit 3 to control the operations of the MOS transistors 10 to 14 makes it possible to zap the resistances 5 to 9 at arbitrary timing and to control the circuit characteristics. Particularly, even in a case where shifts are caused in characteristics of other parts, an assembled product manufacturer can correct the shifts by use of the IC chip including the control circuit 3. As a result, even in a case where parts having large tolerance are purchased, adjustment after assembly is possible. Thus, even if purchase costs are reduced, it is possible to maintain product quality.

Note that, as described above, in this embodiment, the description has been given of the case where the MOS transistors are used as elements for zapping the resistances. However, the present invention is not limited to the above case. For example, bipolar transistors may be used as the elements for zapping the resistances. Since it is possible to zap the resistances with a low current and a low voltage, it is possible to reduce an element size also in the case where the bipolar transistors are used. Besides the above, various changes can be made without departing from the gist of the present invention.

In the embodiment of the present invention, the resistances are formed of the polysilicon film, the tungsten silicon film or the like, and the resistances are partially or completely fused by the currents supplied from the transistors. Moreover, by adjusting a length or a width of the resistances, a current value and a voltage value, which are required for zapping, are arbitrarily set.

Moreover, in the embodiment of the present invention, using the resistances which are partially or completely fused with a low current and a low voltage makes it possible to use the MOS transistors as the driver elements. This circuit configuration makes it possible to reduce the region in which to form the driver elements. Thus, it is possible to reduce the IC chip area.

Moreover, in the embodiment of the present invention, the zapping circuit includes the control circuit for controlling the MOS transistors which are the driver elements for zapping. This circuit configuration makes it possible to partially or completely fuse the resistances, and to thus control the circuit characteristics, based on results of testing circuit characteristics in a wafer state, after resin molding and in a state close to a final product form.

Moreover, in the embodiment of the present invention, the control circuit included in the IC chip controls the MOS transistors that are the driver elements. Moreover, signals to be sent to the control circuit are inputted to the control circuit from leads drawn out of the package. With this circuit configuration, the number of leads for signal input is reduced. Thus, it is possible to reduce the number of leads drawn out of the package.

What is claimed is:

1. A zapping circuit comprising:
resistances connected to a power supply circuit; and
transistors which supply currents to the resistances, wherein
the transistors have a current capacity to partially or completely fuse the resistances.

2. The zapping circuit as recited in claim 1, wherein
the transistors are MOS transistors.

3. The zapping circuit as recited in claim 2, further comprising
a control circuit which controls operations of the MOS transistors,
wherein the MOS transistors are operated based on control signals from the control circuit.

4. The zapping circuit as recited in claim 3, wherein
the plurality of resistances and the plurality of MOS transistors are respectively paired with each other, and connected in parallel to the power supply circuit, and
the MOS transistors are selectively turned on based on the control signals from the control circuit.

5. The zapping circuit as recited in claim 4, further comprising
a sense circuit which detects changes in resistance values respectively of the resistances.

6. The zapping circuit as recited in any one of claims 1 and 2, wherein
the resistances are formed of any one of a polysilicon film and a tungsten silicon film.

7. The zapping circuit as recited in any one of claims 1 and 2, wherein
the resistances have resistance values of 10Ω to 1 kΩ.
